(19) United States
(12) Patent Application Publication
(10) Pub. No.: US 2026/0142192 A1
(43) Pub. Date: May 21, 2026

(54) METAL-AIR FLOW BATTERY CELL AND METAL-AIR FLOW BATTERY STACK

(71) Applicant: SHARP KABUSHIKI KAISHA, Osaka (JP)

(72) Inventors: HIROTAKA MIZUHATA, Osaka (JP); Shinobu TAKENAKA, Osaka (JP); Tomo KITAGAWA, Osaka (JP)

(21) Appl. No.: 19/351,516

(22) Filed: Oct. 7, 2025

(30) Foreign Application Priority Data
Oct. 7, 2024 (JP) 2024-175436

(51) Int. Cl. H01M 4/86; H01M 8/0276; H01M 8/18

(52) U.S. Cl. CPC H01M 4/86; H01M 8/0276; H01M 8/188

(57) ABSTRACT

A metal-air flow battery cell includes: a negative-electrode flow-channel layer including an inlet, a first flow channel, a negative-electrode chamber, a second flow channel, and an outlet, the negative-electrode flow-channel layer being configured to guide a slurry containing active-material particles and an electrolytic solution, the negative-electrode chamber including an entrance and an exit, the entrance being connected to the first flow channel, the exit being connected to the second flow channel; and a negative electrode including a negative-electrode surface disposed perpendicularly below the negative-electrode chamber, wherein the negative-electrode surface and a first lower surface are arranged along a first coplanar plane at the entrance, the first lower surface being disposed perpendicularly below the first flow channel, and the negative-electrode surface and a second lower surface are arranged along a second coplanar plane at the exit, the second lower surface being disposed perpendicularly below the second flow channel.

### CROSS-REFERENCE TO RELATED APPLICATION

The present application claims priority from Japanese Application JP2024-175436, the content of which is hereby incorporated by reference into this application.

### BACKGROUND OF THE INVENTION

### 1. Field of the Invention

The present disclosure relates to a metal-air flow battery cell and a metal-air flow battery stack.

### 2. Description of the Related Art

Japanese Unexamined Patent Application Publication No. 2015-215948 discloses a redox flow battery. The redox flow battery has a cell stack, in which a negative-electrode chamber, an inflow channel, and an outflow channel. A negative-electrode electrolytic solution flows from the inflow channel into the negative-electrode chamber and flows out from the negative-electrode chamber to the outflow channel. The surface of a bipolar plate constitutes the wall surface of the negative-electrode chamber. The wall surface of the negative-electrode chamber and the wall surface of the inflow channel form a step difference. The wall surface of the negative-electrode chamber and the wall surface of the outflow channel form a step difference (paragraphs 0021 to 0022, paragraphs 0024 to 0027, and FIG. 2).

### SUMMARY OF THE INVENTION

A negative-electrode solution included in a metal-air flow battery includes negative-electrode active-material particles and an electrolytic solution and has a slurry shape.

The negative-electrode active-material particles accumulate in the step difference on the wall surface of the negative-electrode chamber when a structure similar to that of the redox flow battery disclosed in Japanese Unexamined Patent Application Publication No. 2015-215948 is adopted to the metal-air flow battery. This problem is conspicuous especially when such a step difference is formed on the wall surface disposed perpendicularly below the negative-electrode chamber.

One aspect of the present disclosure has been made in view of the problem. It is an object of one aspect of the present disclosure to provide a metal-air flow battery cell and a metal-air flow battery stack that, for instance, can prevent accumulation of negative-electrode active-material particles.

A metal-air flow battery cell according to a first aspect of the present disclosure includes the following: a negative-electrode flow-channel layer including an inlet, a first flow channel, a negative-electrode chamber, a second flow channel, and an outlet, the negative-electrode flow-channel layer being configured to guide a slurry containing active-material particles and an electrolytic solution from the inlet sequentially through the first flow channel, through the negative-electrode chamber, through the second flow channel to the outlet, the negative-electrode chamber including an entrance and an exit, the entrance being connected to the first flow channel, the exit being connected to the second flow channel; and a negative electrode including a negative-electrode surface disposed perpendicularly below the negative-electrode chamber. The negative-electrode surface and a first lower surface are arranged along a first coplanar plane at the entrance, the first lower surface being disposed perpendicularly below the first flow channel. The negative-electrode surface and a second lower surface are arranged along a second coplanar plane at the exit, the second lower surface being disposed perpendicularly below the second flow channel.

A metal-air flow battery stack according to a second aspect of the present disclosure includes the following: the metal-air flow battery cell according to the first aspect of the present disclosure; and an adjacent metal-air flow battery cell adjacent to the metal-air flow battery cell. The negative electrode includes a back surface opposite to the negative-electrode surface. The metal-air flow battery cell includes an insulating member including the first lower surface and the second lower surface, and a seal portion disposed on the back surface and sealing a space between the negative electrode and the insulating member. The adjacent metal-air flow battery cell includes a positive electrode adjacent to the negative electrode. The seal portion blocks a flow path of the slurry extending from the negative-electrode surface to the positive electrode.

### BRIEF DESCRIPTION OF THE DRAWINGS

FIG. 1 schematically illustrates a metal-air flow battery according to a first embodiment;

FIG. 2 is a schematic enlarged cross-sectional view of a negative-electrode solution included in the metal-air flow battery according to the first embodiment;

FIG. 3 is a schematic enlarged cross-sectional view of a positive-electrode solution included in the metal-air flow battery according to the first embodiment;

FIG. 4 is a schematic cross-sectional view of a charging stack, the negative-electrode solution, and the positive-electrode solution all included in the metal-air flow battery according to the first embodiment;

FIG. 5 is a schematic exploded perspective view of a frame, a seal portion, a negative electrode, a negative-electrode flow-channel layer, and a positive electrode all included in the metal-air flow battery according to the first embodiment;

FIG. 6 is a schematic exploded perspective view of the frame, seal portion, negative electrode, negative-electrode flow-channel layer, and positive electrode included in the metal-air flow battery according to the first embodiment;

FIG. 7 is a schematic perspective view of the negative electrode and negative-electrode flow-channel layer included in the metal-air flow battery according to the first embodiment;

FIG. 8 is a schematic enlarged cross-sectional view of the negative electrode, the negative-electrode flow-channel layer, and a first seal portion all included in the metal-air flow battery according to the first embodiment;

FIG. 9 is a schematic cross-sectional view of the negative electrode, the negative-electrode flow-channel layer, and a second seal portion all included in the metal-air flow battery according to the first embodiment;

FIG. 10 is a schematic enlarged cross-sectional view of the negative electrode, negative-electrode flow-channel layer, and first seal portion included in the metal-air flow battery according to a first modification of the first embodiment;

FIG. 11 is a schematic enlarged cross-sectional view of the negative electrode, negative-electrode flow-channel layer, and second seal portion included in the metal-air flow battery according to the first modification of the first embodiment;

FIG. 12 is a schematic cross-sectional view of a discharging cell and the negative-electrode solution both included in a discharging stack included in the metal-air flow battery according to the first embodiment;

FIG. 13 is a schematic cross-sectional view of the charging stack, negative-electrode solution, and positive-electrode solution included in the metal-air flow battery according to a second embodiment;

FIG. 14 is a schematic exploded perspective view of an insulating member, a seal portion, a negative electrode, a seal portion, and a negative-electrode flow-channel layer all included in the metal-air flow battery according to the second embodiment;

FIG. 15 is a schematic exploded perspective view of the insulating member, seal portion, negative electrode, seal portion, and negative-electrode flow-channel layer included in the metal-air flow battery according to the second embodiment; and

FIG. 16 is a schematic cross-sectional view of another example discharging cell included in the metal-air flow battery according to the second embodiment.

### DETAILED DESCRIPTION OF THE INVENTION

Embodiments of the present disclosure will be described with reference to the drawings.

It is noted that identical or equivalent constituents will be denoted by the same signs throughout the drawings, and the descriptions of redundancies will be omitted.

### 1 First Embodiment

### 1.1. Metal-Air Flow Battery

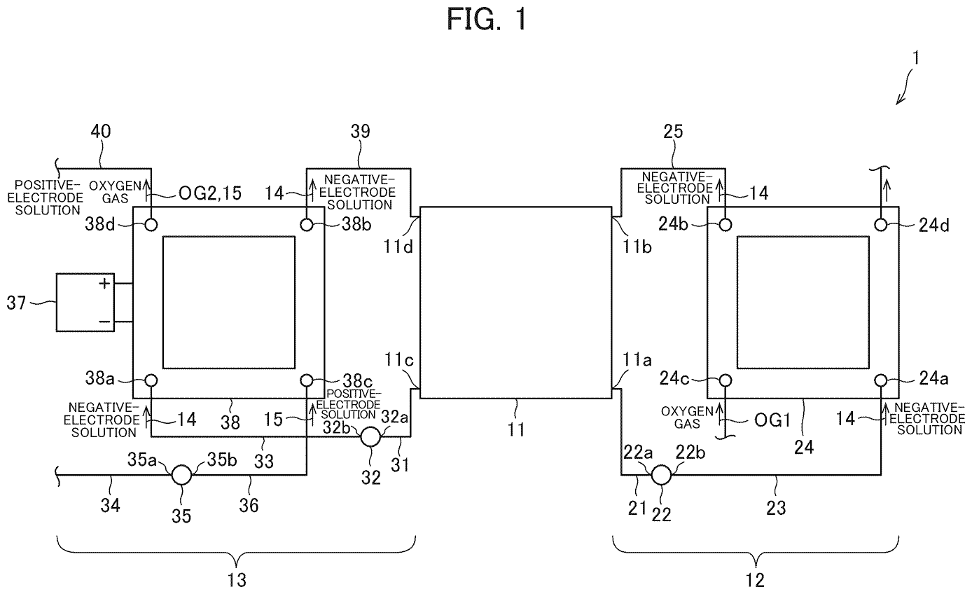

FIG. 1 schematically illustrates a metal-air flow battery according to a first embodiment.

A metal-air flow battery 1 according to the first embodiment illustrated in FIG. 1 absorbs oxygen gas OG1 from air around the metal-air flow battery 1 during its discharge. The metal-air flow battery 1 discharges oxygen gas OG2 to the air around the metal-air flow battery 1 during its charge.

The metal-air flow battery 1 according to the first embodiment is a zinc-air flow battery. The metal-air flow battery 1 thus has negative-electrode active substances that are zinc species. However, the metal-air flow battery 1 may be a metal-air flow battery other than a zinc-air flow battery. The metal-air flow battery 1 may thus have negative-electrode active materials that are metal species other than zinc species. Examples of the metal species other than a zinc species include a cadmium species, a lithium species, a sodium species, a magnesium species, a lead species, a tin species, an aluminum species, and an iron species. The metal constituting the metal species may be a metal only that is a major constituent, or an alloy of a metal that is a major constituent and an accessory constituent. The metal species can be either a metal or an oxide. That the metal species is either a metal or an oxide depends on how much a discharge reaction or a charge reaction progresses.

As illustrated in FIG. 1, the metal-air flow battery 1 includes a storage unit 11, a discharging unit 12, a charging unit 13, a negative-electrode solution 14, and a positive-electrode solution 15.

### 1.2 Discharging Unit

The discharging unit 12 receives the oxygen gas OG1 contained in air around the discharging unit 12. The discharging unit 12 receives the negative-electrode solution 14 from the storage unit 11. The discharging unit 12 causes the received oxygen gas OG1 and negative-electrode solution 14 to get involved in a discharge reaction for generating discharging power, and causes the negative-electrode solution 14 involved in the discharge reaction to flow out to the storage unit 11. The discharging unit 12 causes the oxygen gas OG1, and negative-electrode active-material particles in a reduction state, which are included in the negative-electrode solution 14, to get involved in the discharge reaction to oxidize the negative-electrode active-material particles in the reduction state to generate active-material ions.

As illustrated in FIG. 1, the discharging unit 12 includes a pipe 21, a pump 22, a pipe 23, a discharging stack 24, and a pipe 25.

The pipe 21 guides the negative-electrode solution 14 from an outlet 11a of the storage unit 11 to an inlet 22a of the pump 22. The pipe 21 accordingly allows the negative-electrode solution 14 flowed out of the outlet 11a to flow into the inlet 22a.

The pump 22 causes the negative-electrode solution 14 flowed into the inlet 22a of the pump 22 to flow out of an outlet 22b of the pump 22. The pump 22 generates a flow of the negative-electrode solution 14 at this time. The pump 22 accordingly sends the negative-electrode solution 14 from the storage unit 11 to the discharging stack 24.

The pipe 23 guides the negative-electrode solution 14 from the outlet 22b of the pump 22 to an inlet 24a of the discharging stack 24. The pipe 23 accordingly allows the negative-electrode solution 14 flowed out of the outlet 22b to flow into the inlet 24a.

The discharging stack 24 allows the negative-electrode solution 14 flowed into the inlet 24a of the discharging stack 24 to flow out of an outlet 24b of the discharging stack 24. The discharging stack 24 takes in the air around the discharging unit 12 from an intake port 24c of the discharging stack 24, absorbs the oxygen gas OG1 contained in the taken air, and discharges the air with the oxygen gas OG1 absorbed therein from an exhaust port 24d of the discharging stack 24. The discharging stack 24 causes the absorbed oxygen gas OG1 and the negative-electrode solution 14 flowed into the inlet 24a of the discharging stack 24 to get involved in a discharge reaction, and causes the negative-electrode solution 14 involved in the discharge reaction to flow out to the outlet 24b. The discharging stack 24 outputs discharge power generated through the discharge reaction.

The pipe 25 guides the negative-electrode solution 14 from the outlet 24b of the discharging stack 24 to the inlet 11b of the storage unit 11. The pipe 25 accordingly allows the negative-electrode solution 14 flowed out of the outlet 24b to flow into the inlet 11b.

### 1.3 Charging Unit

The charging unit 13 receives the negative-electrode solution 14 from the storage unit 11. The charging unit 13 causes the received negative-electrode solution 14 to get involved in a charge reaction for reproducing the negative-electrode solution 14, and causes the negative-electrode solution 14 involved in the charge reaction to flow out to the storage unit 11. The charging unit 13 causes the active-material ions contained in the negative-electrode solution 14 to get involved in a charge reaction to reduce the active-material ions to generate negative-electrode active-material particles in a reduction state and generate the oxygen gas OG2. The charging unit 13 discharges the generated oxygen gas OG2 to air around the charging unit 13.

As illustrated in FIG. 1, the charging unit 13 includes a pipe 31, a pump 32, a pipe 33, a pipe 34, a pump 35, a pipe 36, a power supply 37, a charging stack 38, a pipe 39, and a pipe 40.

The pipe 31 guides the negative-electrode solution 14 from an outlet 11c of the storage unit 11 to an inlet 32a of the pump 32. The pipe 31 accordingly allows the negative-electrode solution 14 flowed out of the outlet 11c to flow into the inlet 32a.

The pump 32 causes the negative-electrode solution 14 flowed into the inlet 32a of the pump 32 to flow out of an outlet 32b of the pump 32. The pump 32 generates a flow of the negative-electrode solution 14 at this time. The pump 32 accordingly sends the negative-electrode solution 14 from the storage unit 11 to the charging stack 38.

The pipe 33 guides the negative-electrode solution 14 from the outlet 32b of the pump 32 to an inlet 38a of the charging stack 38. The pipe 33 accordingly allows the negative-electrode solution 14 flowed out of the outlet 32b to flow into the inlet 38a.

The pipe 34 guides the positive-electrode solution 15 from a supply source (not shown) of the positive-electrode solution 15 to an inlet 35a of the pump 35. The pipe 34 accordingly allows the positive-electrode solution 15 flowed out of the supply source of the positive-electrode solution 15 to flow into the inlet 35a.

The pump 35 causes the positive-electrode solution 15 flowed into the inlet 35a of the pump 35 to flow out of an outlet 35b of the pump 35. The pump 35 generates a flow of the positive-electrode solution 15 at this time. The pump 35 accordingly sends the positive-electrode solution 15 from the supply source of the positive-electrode solution 15 to the charging stack 38.

The pipe 36 guides the negative-electrode solution 15 from the outlet 35b of the pump 35 to an inlet 38c of the charging stack 38. The pipe 36 accordingly allows the positive-electrode solution 15 flowed out of the outlet 35b to flow into the inlet 38c.

The power supply 37 inputs charging power to the charging stack 38.

The charging stack 38 causes the negative-electrode solution 14 flowed into the inlet 38a of the charging stack 38 to flow out of an outlet 38b of the charging stack 38, and causes the positive-electrode solution 15 flowed into the inlet 38c of the charging stack 38 to flow out of an outlet 38d of the charging stack 38. The charging stack 38 at this time causes the flowed negative-electrode solution 14 and positive-electrode solution 15 to get involved in a charge reaction caused by the charging power, causes the negative-electrode solution 14 involved in the charge reaction to flow out of the outlet 38b, causes the positive-electrode solution 15 involved in the charge reaction to flow out of the outlet 38d, and discharges the oxygen gas OG2 generated through the charge reaction from the outlet 38d.

The pipe 39 guides the negative-electrode solution 14 from the outlet 38b of the charging stack 38 to the inlet 11d of the storage unit 11. The pipe 39 accordingly allows the negative-electrode solution 14 flowed out of the outlet 38b to flow into the inlet 11d.

The pipe 40 guides the positive-electrode solution 15 from the outlet 38d of the charging stack 38 to the supply source of the positive-electrode solution 15. The pipe 40 accordingly allows the positive-electrode solution 15 flowed out of the outlet 38d to flow into the supply source of the positive-electrode solution 15.

### 1.4 Negative-Electrode Solution

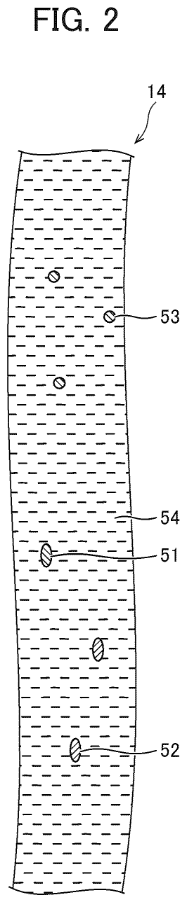

FIG. 2 is a schematic enlarged cross-sectional view of the negative-electrode solution included in the metal-air flow battery according to the first embodiment.

As illustrated in FIG. 2, the negative-electrode solution 14 includes negative-electrode active-material particles 51 in a reduction state, negative-electrode active-material particles 52 in an oxidation state, active-material ions 53, and an electrolytic solution 54. The negative-electrode active-material particles 5 in the reduction state and the negative-electrode active-material particles 52 in the oxidation state are solid negative-electrode active materials.

As earlier described, the metal-air flow battery 1 according to the first embodiment is a zinc-air flow battery. The negative-electrode active-material particles 51 in the reduction state, the negative-electrode active-material particles 52 in the oxidation state, and the active-material ions 53 are thus zinc species. The negative-electrode active-material particles 51 in the reduction state are zinc (Zn) metal particles. The negative-electrode active-material particles 52 in the oxidation state are zinc (ZnO) oxide particles. The negative-electrode active-material particles 51 in the reduction state and the negative-electrode active-material particles 52 in the oxidation state are dispersed in the electrolytic solution 54. The negative-electrode solution 14 is thus a slurry. The negative-electrode active-material particles 51 in the reduction state each measure, for instance, several micrometers in particle diameter. The negative-electrode active-material particles 52 in the oxidation state each measure, for instance, several tens of nanometers to several hundred nanometers in particle diameter. The active-material ions 53 are zincate ions (Zn(OH)₄²⁻). The active-material ions 53 are dissolved in the electrolytic solution 54.

The electrolytic solution 54 is a potassium hydroxide aqueous solution. The electrolytic solution 54 may be an aqueous solution other than a potassium hydroxide aqueous solution, or an electrolytic solution other than an aqueous solution, but it is desirable that the electrolytic solution 54 be an aqueous solution having relatively high ion conductivity, especially a potassium hydroxide aqueous solution.

The active-material ions 53 are a reactant of a charge reaction that occurs in the charging stack 38 and is a product of a discharge reaction that occurs in a discharge module. The negative-electrode active-material particles 51 in the reduction state are a product of the charge reaction that occurs in the charging stack 38 and is a reactant of the discharge reaction that occurs in the discharge module.

### 1.5 Positive-Electrode Solution

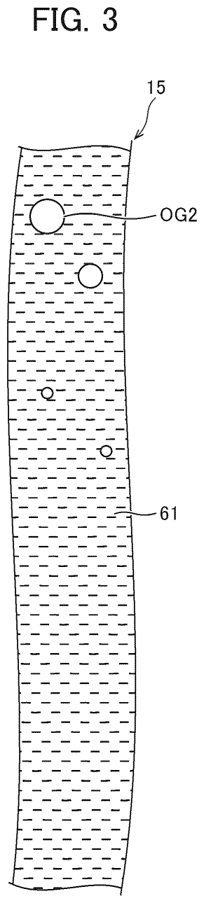

FIG. 3 is a schematic enlarged cross-sectional view of the positive-electrode solution included in the metal-air flow battery according to the first embodiment.

As illustrated in FIG. 3, the positive-electrode solution 15 includes an electrolytic solution 61.

The electrolytic solution 61 is a potassium hydroxide aqueous solution. The electrolytic solution 61 may be an aqueous solution other than a potassium hydroxide aqueous solution, or an electrolytic solution other than an aqueous solution.

### 1.6 Discharge Reaction

A negative-electrode reaction expressed by Chemical Equations (1) and (2) occurs in the negative electrode of the discharging stack 24.

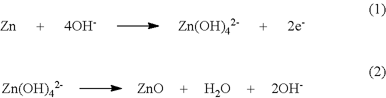

A positive-electrode reaction expressed by Chemical Equation (3) occurs in the positive electrode of the discharging stack 24.

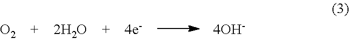

Through the negative-electrode reaction expressed by Chemical Equations (1) and (2) as well as the positive-electrode reaction expressed by Chemical Equation (3), a discharge reaction expressed by Chemical Equation (4) occurs in the discharging stack 24.

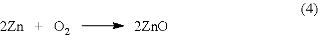

### 1.7 Charge Reaction

A negative-electrode reaction expressed by Chemical Equations (5) and (6) occurs in the negative electrode of the charging stack 38.

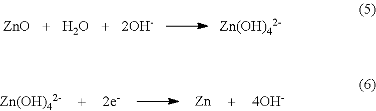

A positive-electrode reaction expressed by Chemical Equation (7) occurs in the positive electrode of the charging stack 38.

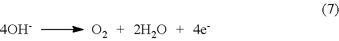

Through the negative-electrode reaction expressed by Chemical Equations (5) and (6) as well as the positive-electrode reaction expressed by Chemical Equation (7), a charge reaction expressed by Chemical Equation (8) occurs in the charging stack 38.

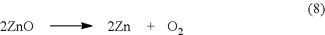

### 1.8 Charging Stack

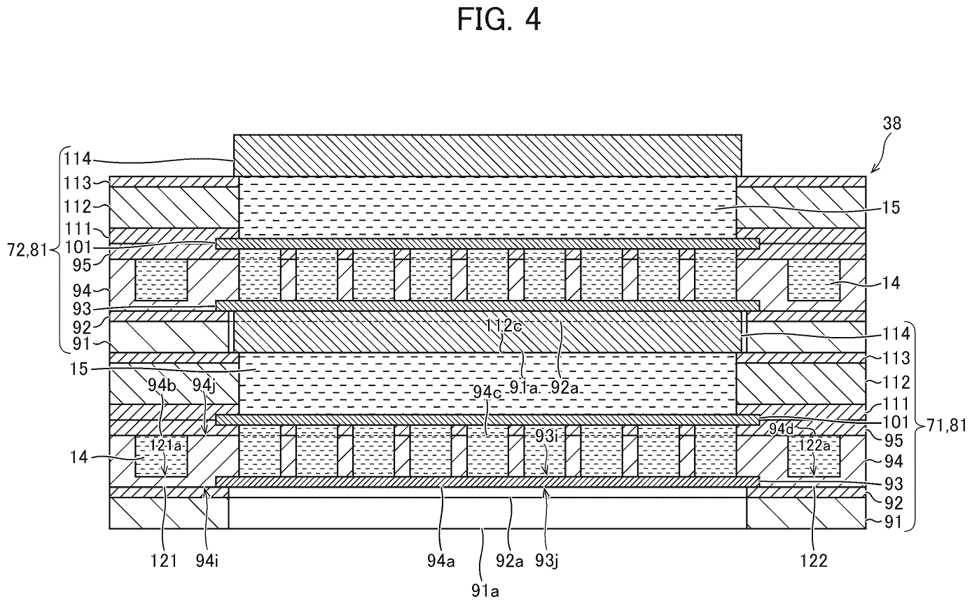

FIG. 4 is a schematic cross-sectional view of the charging stack, negative-electrode solution, and positive-electrode solution all included in the metal-air flow battery according to the first embodiment.

As illustrated in FIG. 4, the charging stack 38 includes a charging cells 71 and 72. The number of charging cells that are included in the charging stack 38 may be increased or decreased from two.

### 1.9 Charging Cells

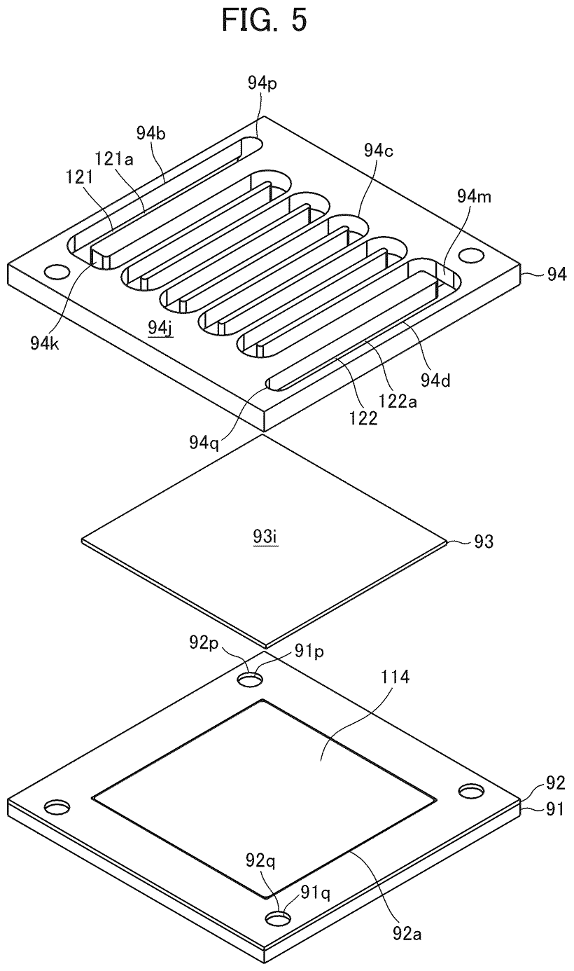

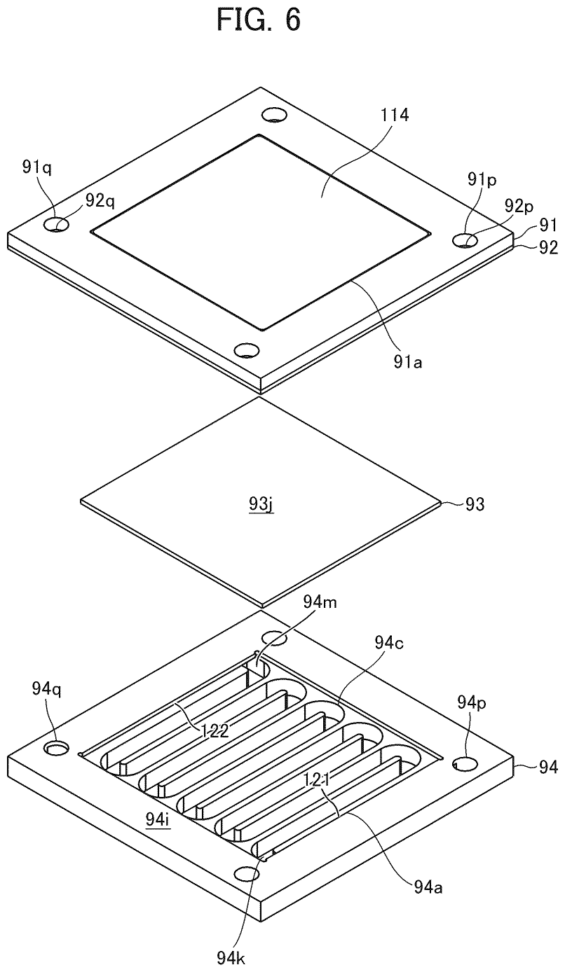

FIGS. 5 and 6 are schematic exploded perspective views of a frame, a seal portion, a negative electrode, a negative-electrode flow-channel layer, and a positive electrode all included in the metal-air flow battery according to the first embodiment.

As illustrated in FIGS. 4 to 6, each of charging cells 81 included in the respective charging cells 71 and 72 includes a frame 91, a seal portion 92, a negative electrode 93, a negative-electrode flow-channel layer 94, a seal portion 95, a separator 101, a seal portion 111, a positive-electrode flow-channel layer 112, a seal portion 113, and a positive electrode 114.

The frame 91, the seal portion 92, the negative electrode 93, the negative-electrode flow-channel layer 94, the seal portion 95, the separator 101, the seal portion 111, the positive-electrode flow-channel layer 112, the seal portion 113, and the positive electrode 114 are stacked perpendicularly from bottom toward top in the stated order.

The frame 91 has a frame shape. The frame 91 includes an opening 91a. The opening 91a penetrates the frame 91 in the thickness direction of the frame 91. The opening 91a has a planar shape smaller than the planer shape of the negative electrode 93, and larger than the planar shape of the positive electrode 114. The negative electrode 93 cannot enter the opening 91a, and the positive electrode 114 can enter the opening 91a.

The frame 91 includes holes 91p and 91q. The holes 91p and 91q penetrate the frame 91 in the thickness direction of the frame 91.

The frame 91 is formed from an insulator.

The seal portion 92 has a frame shape. The seal portion 92 includes an opening 92a. The opening 92a penetrates the seal portion 92 in the thickness direction of the seal portion 92. The opening 92a has a planar shape smaller than the planer shape of the negative electrode 93, and larger than the planar shape of the positive electrode 114. The negative electrode 93 can enter the opening 92a, and the positive electrode 114 can enter the opening 92a.

The seal portion 92 includes holes 92p and 92q. The holes 92p and 92q penetrate the seal portion 92 in the thickness direction of the seal portion 92.

The seal portion 92 has a planar shape identical to the planar shape of the frame 91.

The seal portion 92 is sandwiched by the frame 91 and a composite of the negative electrode 93 and negative-electrode flow-channel layer 94. The seal portion 92 has a sheet shape. The seal portion 92 is formed from an elastic body, such as rubber. The seal portion 92 seals the space between the frame 91 and the composite of the negative electrode 93 and negative-electrode flow-channel layer 94.

The seal portion 92 is formed from an insulator.

The negative electrode 93 has a plate shape. The negative electrode 93 has a negative-electrode surface 93i and a back surface 93j. The negative-electrode surface 93i and the back surface 93j are main surfaces opposite to each other.

The negative electrode 93 is formed from a conductor, for example, magnesium alloy or carbon.

The negative-electrode flow-channel layer 94 has a perforated-board shape. The negative-electrode flow-channel layer 94 includes a first main surface 94i and a second main surface 94j. The first main surface 94i and the second main surface 94j are opposite to each other.

The negative-electrode flow-channel layer 94 includes a recess 94a, a first flow channel 94b, a negative-electrode chamber 94c, and a second flow channel 94d. The recess 94a is formed close to the first main surface 94i of the negative-electrode flow-channel layer 94. The first flow channel 94b, the negative-electrode chamber 95c, and the second flow channel 94d are formed closed to the second main surface 94j of the negative-electrode flow-channel layer 94. The negative-electrode chamber 94c is between the negative electrode 93 and the separator 101. The recess 94a and the negative-electrode chamber 94c are connected to each other between the first main surface 94i and the second main surface 94j. The first flow channel 94b and the second flow channel 94d do not penetrate the negative-electrode flow-channel layer 94 in the thickness direction of the negative-electrode flow-channel layer 94. The negative-electrode flow-channel layer 94 includes a first lower surface 121a and a second lower surface 122a disposed perpendicularly below the first flow channel 94b and the second flow channel 94d, respectively. The negative-electrode flow-channel layer 94 includes a first insulating portion 121 including the first lower surface 121a, and a second insulating portion 122 including the second lower surface 122a. The recess 94a has a shape matching the shape of the negative electrode 93. The recess 94a is fitted in the negative electrode 93. The negative-electrode surface 93i of the negative electrode 93 is disposed perpendicularly below the negative-electrode chamber 94c. The first lower surface 121a, the second lower surface 122a, and the negative-electrode surface 93i face the first flow channel 94b, the second flow channel 94d, and the negative-electrode chamber 94c, respectively. The first insulating portion 121, the negative electrode 93, and the second insulating portion 122 are each in contact with the negative-electrode solution 14 flowing through the first flow channel 94b, second flow channel 94d, and negative-electrode chamber 94c.

The first main surface 94i of the negative-electrode flow-channel layer 94 and the back surface 93j of the negative electrode 93 are flush with each other. The seal portion 92 is in abutment with the edges of the first main surface 94i and back surface 93j. The seal portion 92 seals the space between the frame 91 and the composite of the negative electrode 93 and negative-electrode flow-channel layer 94, so that the components of the negative-electrode solution 14 flowing through the negative-electrode flow-channel layer 94 can be prevented from leaking to the positive electrode 114, which is disposed on the back surface 93j of the negative electrode 93.

The negative-electrode flow-channel layer 94 includes an inlet 94p and an outlet 94q. The inlet 94p and the outlet 94q penetrate the negative-electrode flow-channel layer 94 in the thickness direction of the negative-electrode flow-channel layer 94.

The negative-electrode chamber 94c of the negative-electrode flow-channel layer 94 includes an entrance 94k and an exit 94m. The first flow channel 94b of the negative-electrode flow-channel layer 94 has one end connected to the inlet 94p of the negative-electrode flow-channel layer 94. The first flow channel 94b has the other end connected to the entrance 94k. The second flow channel 94d of the negative-electrode flow-channel layer 94 has one end connected to the exit 94m. The second flow channel 94d has the other end connected to the outlet 94q of the negative-electrode flow-channel layer 94. The inlet 94p, the first flow channel 94b, the negative-electrode chamber 94c, the second flow channel 94d, and the outlet 94q communicate with one another. The negative-electrode flow-channel layer 94 guides the negative-electrode solution 14 from the inlet 94p sequentially through the first flow channel 94b, through the negative-electrode chamber 94c, through the second flow channel 94d to the outlet 94q.

Negative-electrode active-material particles including the negative-electrode active-material particles 51 in the reduction state and the negative-electrode active-material particles 52 in the oxidation state (hereinafter, merely referred to as negative-electrode active-material particles) settled downward perpendicularly under the influence of gravity. As such, the flow of the negative-electrode solution 14 flowing through the first flow channel 94b is a sliding flow in which the negative-electrode active-material particles flow while crawling on the first lower surface 121a of the negative-electrode flow-channel layer 94. The flow of the negative-electrode solution 14 flowing through the negative-electrode chamber 94c is a sliding flow in which the negative-electrode active-material particles flow while crawling on the negative-electrode surface 93i of the negative electrode 93. This can enhance the efficiency of contact between the negative-electrode active-material particles and the negative electrode 93. The flow of the negative-electrode solution 14 flowing through the second flow channel 94d is a sliding flow in which the negative-electrode active-material particles flow while crawling on the second lower surface 122a of the negative-electrode flow-channel layer 94.

The negative-electrode flow-channel layer 94 is formed from an insulator. The first insulating portion 121 and the second insulating portion 122 are formed from an insulator.

The seal portion 95 is sandwiched by the negative-electrode flow-channel layer 94 and the separator 101. The seal portion 95 has a sheet shape. The seal portion 95 is formed from an elastic body, such as rubber. The seal portion 95 seals the space between the negative-electrode flow-channel layer 94 and separator 101.

The seal portion 95 is formed from an insulator.

The separator 101 has a sheet shape. The separator 101 is sandwiched by the seal portion 95 and the seal portion 111 and is disposed between the negative-electrode flow-channel layer 94 and the positive-electrode flow-channel layer 112. The separator 101 separates the negative-electrode chamber 94c of the negative-electrode flow-channel layer 94 and a positive-electrode chamber 112c of the positive-electrode flow-channel layer 112 from each other. The separator 101 faces the negative electrode 93 with the negative-electrode chamber 94c interposed therebetween, and the separator 101 faces the positive electrode 114 with the positive-electrode chamber 112c interposed therebetween.

The separator 101 prevents the negative-electrode active-material particles 51 in the reduction state, the negative-electrode active-material particles 52 in the oxidation state, and the active-material ions 53 from passing therethrough. The separator 101 thus prevents the negative-electrode active-material particles 51 in the reduction state, the negative-electrode active-material particles 52 in the oxidation state, and the active-material ions 53 from moving from the negative-electrode solution 14 to the positive-electrode solution 15.

The separator 101 allows hydroxide ions (OH) to pass therethrough. The separator 101 thus enables the hydroxide ions, OH, to move from the negative-electrode solution 14 to the positive-electrode solution 15.

The seal portion 111 is sandwiched by the separator 101 and the positive-electrode flow-channel layer 112. The seal portion 111 has a sheet shape. The seal portion 111 is formed from an elastic body, such as rubber. The seal portion 111 seals the space between the the separator 101 and the negative-electrode flow-channel layer 94.

The seal portion 111 is formed from an insulator.

The positive-electrode flow-channel layer 112 has a perforated-board shape.

The positive-electrode chamber 112c is formed in the positive-electrode flow-channel layer 112. The positive-electrode chamber 112c is between the positive electrode 114 and the separator 101.

The positive-electrode flow-channel layer 112 is formed from an insulator.

The seal portion 113 is sandwiched by the positive-electrode flow-channel layer 112 and the positive electrode 114. The seal portion 113 has a sheet shape. The seal portion 113 is formed from an elastic body, such as rubber. The seal portion 113 seals the space between the positive-electrode flow-channel layer 112 and the positive electrode 114.

The seal portion 113 is formed from an insulator.

The positive electrode 114 has a plate shape.

The positive electrode 114 is formed from a conductor, for example, carbon or nickel.

The positive electrode 114 included in the charging cell 71 is disposed astride a space formed from the opening 91a of the frame 91 included in the adjacent charging cell 72, which is adjacent to the charging cell 71, and from the opening 92a of the seal portion 92 included in the adjacent charging cell 72.

The positive electrode 114 included in the charging cell 71 and the negative electrode 93 included in the adjacent charging cell 72 are in contact with each other and electrically connected to each other. The charging cells 71 and 72 are electrically connected in series. When the positive electrode 114 and the negative electrode 93 electrically connected to each other are made of the same material, the positive electrode 114 and the negative electrode 93 electrically connected to each other may be an integrated piece.

### 1.10 Manifolds of Charging Stack

The holes 91p and 92p and the inlet 94p extend along the same straight line, have the same hole shape and constitute a first manifold through which the negative-electrode solution 14 flows.

The holes 91q and 92q and the outlet 94q extend along the same straight line, have the same hole shape and constitute a second manifold through which the negative-electrode solution 14 flows.

The charging stack 38 guides the negative-electrode solution 14 from the first manifold through the first flow channel 94b, through the negative-electrode chamber 94c, through the second flow channel 94d to the second manifold.

### 1.11 Step Difference of Negative-Electrode Chamber

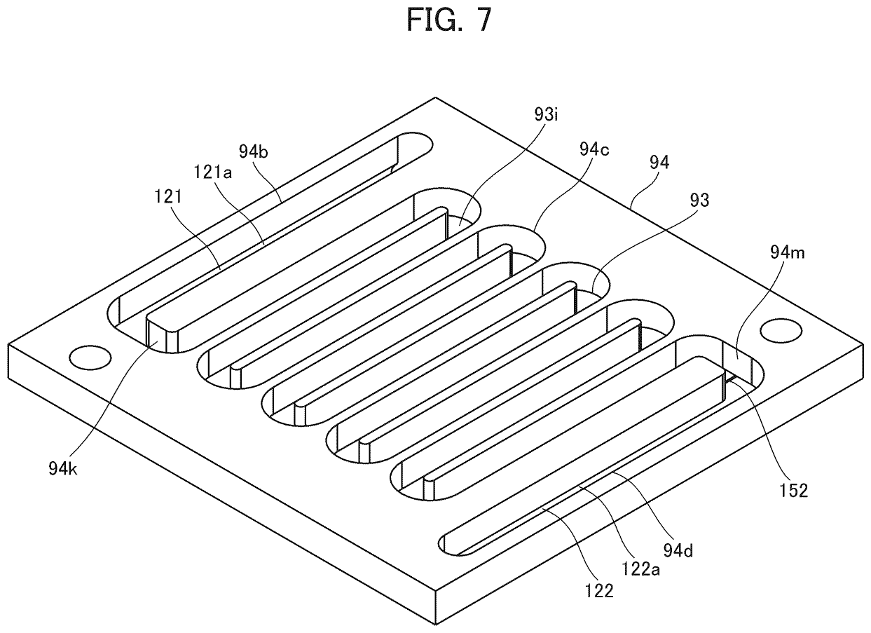

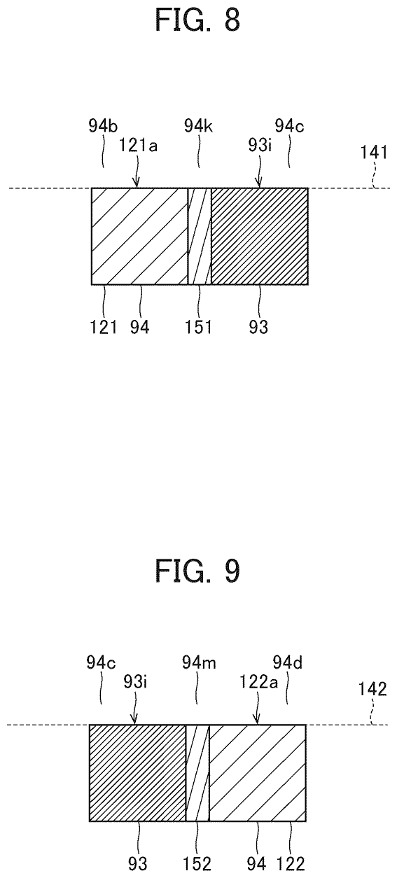

FIG. 7 is a schematic perspective view of the negative electrode and negative-electrode flow-channel layer included in the metal-air flow battery according to the first embodiment. FIG. 8 is a schematic enlarged cross-sectional view of the negative electrode, the negative-electrode flow-channel layer, and a first seal portion all included in the metal-air flow battery according to the first embodiment. FIG. 9 is a schematic cross-sectional view of the negative electrode, the negative-electrode flow-channel layer, and a second seal portion all included in the metal-air flow battery according to the first embodiment.

As illustrated in FIGS. 7 to 9, the negative-electrode surface 93i of the negative electrode 93 and the first lower surface 121a of the negative-electrode flow-channel layer 94 are arranged along a first coplanar plane 141 at the entrance 94k of the negative-electrode chamber 94c of the negative-electrode flow-channel layer 94, and they are desirably arranged along the first coplanar plane 141 at both of the entrance 94k and the other sites. The negative-electrode surface 93i of the negative electrode 93 and the second lower surface 122a of the negative-electrode flow-channel layer 94 are arranged along a second coplanar plane 142 at the exit 94m of the negative-electrode chamber 94c of the negative-electrode flow-channel layer 94, and they are desirably arranged along the second coplanar plane 142 at both of the exit 94m and the other sites. This prevents a step difference from forming at the entrance 94k and exit 94m. Accordingly, the negative-electrode active-material particles crawling on the first lower surface 121a, negative-electrode surface 93i, and second lower surface 122a can be prevented from being held back by the formed step difference and thus accumulating. This can prevent the first flow channel 94b, negative-electrode chamber 94c, and second flow channel 94d of the negative-electrode flow-channel layer 94 from clogging due to the accumulated negative-electrode active-material particles. This can prevent performance degradation of the metal-air flow battery 1. This can also prevent inhibition on long-time operation of the metal-air flow battery 1.

The entire negative-electrode surface 93i of the negative electrode 93 and the entire first lower surface 121a of the negative-electrode flow-channel layer 94 are desirably arranged along the first coplanar plane 141. The entire negative-electrode surface 93i of the negative electrode 93 and the entire second lower surface 122a of the negative-electrode flow-channel layer 94 are arranged along the second coplanar plane 142. The first coplanar plane 141 and the second coplanar plane 142 coincide. As such, the negative-electrode surface 93i, the first lower surface 121a, and the second lower surface 122a are flush with one another.

That the negative-electrode surface 93i of the negative electrode 93 and the first lower surface 121a of the negative-electrode flow-channel layer 94 are arranged along the first coplanar plane 141 means that the difference between the perpendicular position of the negative-electrode surface 93i and the perpendicular position of the first lower surface 121a is small to such an extent as not to inhibit the movement of the negative-electrode active-material particles from the first lower surface 121a to the negative-electrode surface 93i. That the negative-electrode surface 93i of the negative electrode 93 and the second lower surface 122a of the negative-electrode flow-channel layer 94 are arranged along the second coplanar plane 142 means that the difference between the perpendicular position of the negative-electrode surface 93i and the perpendicular position of the second lower surface 122a is small to such an extent as not to inhibit the movement of the negative-electrode active-material particles from the negative-electrode surface 93i to the second lower surface 122a.

The difference between the perpendicular position of the negative-electrode surface 93i and the perpendicular position of the first lower surface 121a is equal to or less than the average particle diameter of the negative-electrode active-material particles, and desirably equal to or less than half the average particle diameter of the negative-electrode active-material particles, at the entrance 94k of the negative-electrode chamber 94c of the negative-electrode flow-channel layer 94. The difference between the perpendicular position of the negative-electrode surface 93i and the perpendicular position of the second lower surface 122a is equal to or less than the average particle diameter of the negative-electrode active-material particles, and desirably equal to or less than half the average particle diameter of the negative-electrode active-material particles, at the exit 94m of the negative-electrode chamber 94c of the negative-electrode flow-channel layer 94. The average particle diameter can be measured using a particle-size-distribution measuring device. The particle-size-distribution measuring device measures particle size distribution through, for instance, a laser diffraction method, or a dynamic light scattering method, and it calculates a median size, D50, as the average particle diameter from the measured particle size distribution. The average particle diameter of the negative-electrode active-material particles measures about 100 μm; thus, the difference between the perpendicular position of the negative-electrode surface 93i and the perpendicular position of the first lower surface 121a is equal to or less than 100 μm, and desirably equal to or less than 50 μm, at the entrance 94k. The difference between the perpendicular position of the negative-electrode surface 93i and the perpendicular position of the second lower surface 122a is equal to or less than 100 μm, and desirably equal to or less than 50 μm, at the exit 94m of the negative-electrode flow-channel layer 94. Accordingly, the negative-electrode active-material particles can go beyond the step difference formed by these differences by the action of the flow of the negative-electrode solution 14. This can prevent the negative-electrode active-material particles from being clogged by the step difference and thus accumulating.

As illustrated in FIGS. 7 to 9, each charging cell 81 may further include a first seal portion 151 and a second seal portion 152.

The first seal portion 151 is disposed between the negative electrode 93 and the first insulating portion 121, and it seals the space between the negative electrode 93 and the first insulating portion 121. The second seal portion 152 is disposed between the negative electrode 93 and the second insulating portion 122, and it seals the space between the negative electrode 93 and the second insulating portion 122.

The negative electrode 93 is formed from a conductor, as earlier described. The first insulating portion 121 and the second insulating portion 122 are formed from an insulator, as earlier described. The first insulating portion 121 and second insulating portion 122, which face the first flow channel 94b and second flow channel 94d of the negative-electrode flow-channel layer 94, are formed from an insulator, so that the mutually adjacent charging cells 71 and 72 can be prevented from an electrical short circuit. When the negative electrode 93 is formed from a conductor, and the first insulating portion 121 and the second insulating portion 122 are formed from an insulator, the material of the negative electrode 93 is different from the materials of the first insulating portion 121 and second insulating portion 122. Hence, an interface or a gap is formed between the negative electrode 93 and the first insulating portion 121, and an interface or a gap is formed between the negative electrode 93 and the second insulating portion 122. There is a possibility that the components of the negative-electrode solution 14 may leak by way of the formed interface or gap when the first seal portion 151 and the second seal portion 152 are not provided. In contrast to this, providing the first seal portion 151 and the second seal portion 152 can prevent the components of the negative-electrode solution 14 from leaking by way of the formed interface or gap.

The perpendicular position of the upper end of the first seal portion 151 is equal to or lower than the perpendicular position of the negative-electrode surface 93i of the negative electrode 93, and equal to or lower than the perpendicular position of the first lower surface 121a of the negative-electrode flow-channel layer 94. This can prevent the first seal portion 151 from protruding perpendicularly upward from the negative-electrode surface 93i or first lower surface 121a to thus form a protrusion. This can thus prevent the negative-electrode active materials from accumulating near the formed protrusion. The perpendicular position of the upper end of the second seal portion 152 is equal to or lower than the perpendicular position of the negative-electrode surface 93i, and equal to or lower than the perpendicular position of the second lower surface 122a of the negative-electrode flow-channel layer 94. This can prevent the second insulating portion 122 from protruding perpendicularly upward from the negative-electrode surface 93i or second lower surface 122a to thus form a protrusion. This can thus prevent the negative-electrode active materials from accumulating near the formed protrusion.

It is desirable that the perpendicular position of the upper end of the first seal portion 151 be equal to the perpendicular position of the negative-electrode surface 93i of the negative electrode 93, and equal to the perpendicular position of the first lower surface 121a of the negative-electrode flow-channel layer 94. This can prevent the first seal portion 151 from being recessed perpendicularly downward from the negative-electrode surface 93i or first lower surface 121a to thus form a recess. This can thus prevent the negative-electrode active materials from accumulating in the formed recess. It is desirable that the perpendicular position of the upper end of the second seal portion 152 be equal to the perpendicular position of the negative-electrode surface 93i, and equal to the perpendicular position of the second lower surface 122a. This can prevent the second seal portion 152 from being recessed perpendicularly downward from the negative-electrode surface 93i or second lower surface 122a to thus form a recess. This can thus prevent the negative-electrode active materials from accumulating in the formed recess.

The first seal portion 151 is a portion formed by welding, fusing, or bonding the negative electrode 93 and the first insulating portion 121 to each other. In addition, the second seal portion 152 is a portion formed by welding, fusing, or bonding the negative electrode 93 and the second insulating portion 122 to each other.

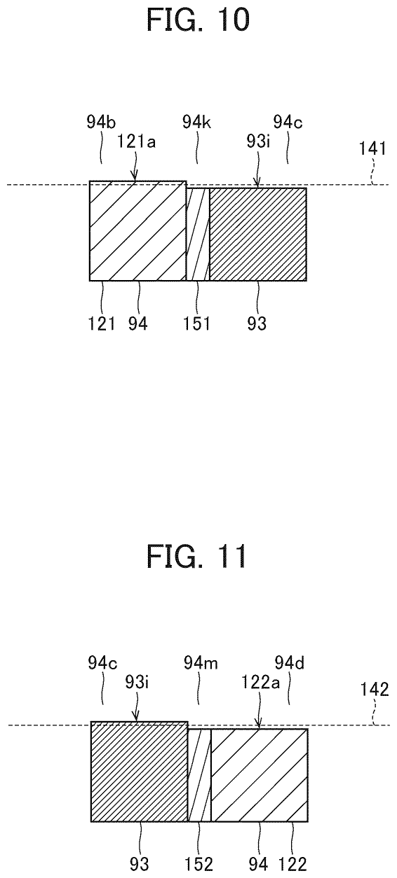

FIG. 10 is a schematic enlarged cross-sectional view of the negative electrode, negative-electrode flow-channel layer, and first seal portion included in the metal-air flow battery according to a first modification of the first embodiment. FIG. 11 is a schematic enlarged cross-sectional view of the negative electrode, negative-electrode flow-channel layer, and second seal portion included in the metal-air flow battery according to the first modification of the first embodiment.

In the first modification of the first embodiment, the perpendicular position of the negative-electrode surface 93i of the negative electrode 93 is lower than the perpendicular position of the first lower surface 121a of the negative-electrode flow-channel layer 94, as illustrated in FIG. 10. Further, the perpendicular position of the second lower surface 122a of the negative-electrode flow-channel layer 94 is lower than the perpendicular position of the negative-electrode surface 93i of the negative electrode 93, as illustrated in FIG. 11. Accordingly, the perpendicular position of the surface on which the negative-electrode active-material particles crawl becomes lower along with approach to the downstream side of the flow of the negative-electrode solution 14. This can prevent accumulation of the negative-electrode active-material particles.

### 1.12 Discharging Stack

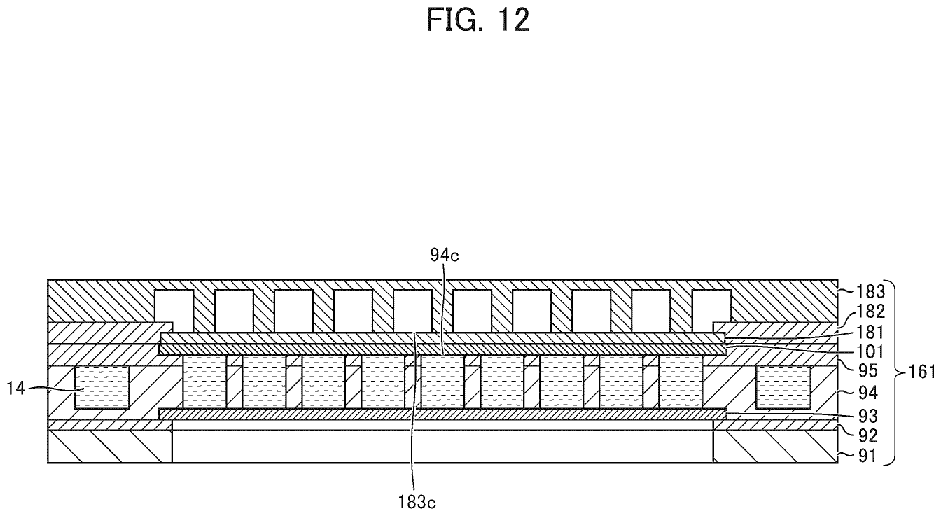

FIG. 12 is a schematic cross-sectional view of each discharging cell and the negative-electrode solution both included in the discharging stack included in the metal-air flow battery according to the first embodiment.

The discharging stack 24 includes a plurality of discharging cells.

As illustrated in FIG. 12, each of discharging cells 161 included in the plurality of discharging cells includes a positive electrode 181, a seal portion 182, and a positive-electrode flow-channel layer 183 instead of the seal portion 111, positive-electrode flow-channel layer 112, seal portion 113, and positive electrode 114 included in each charging cell 81. The positive-electrode flow-channel layer 112 may be disposed in the opening 91a of the frame 91 included in the adjacent discharging cell 161.

The negative electrode 93 included in each discharging cell 161 is formed from a conductor, for example, carbon, titanium, or nickel.

The positive electrode 181 has a plate shape.

The positive electrode 181 faces the negative-electrode chamber 94c of the negative-electrode flow-channel layer 94 with the separator 101 interposed therebetween.

The positive electrode 181 includes a catalytic material, such as manganese dioxide, for promoting an oxygen reduction reaction and includes a conductive material, such as carbon.

The seal portion 182 is sandwiched by a composite of the separator 101 and positive electrode 114, and by the positive-electrode flow-channel layer 112. The seal portion 111 has a sheet shape. The seal portion 182 is formed from an elastic body, such as rubber. The seal portion 182 seals the space between the composite of the separator 101 and positive electrode 114 and the positive-electrode flow-channel layer 112.

The seal portion 182 is formed from an insulator.

The positive-electrode flow-channel layer 183 has a plate shape.

The positive-electrode flow-channel layer 183 includes a positive-electrode chamber 183c.

The positive-electrode flow-channel layer 183 is formed from a conductor.

### 2 Second Embodiment

The following describes a point in which the second embodiment is different from the first embodiment. With regard to what will not be described, a configuration similar to the configuration adopted in the first embodiment will be adopted in the second embodiment as well.

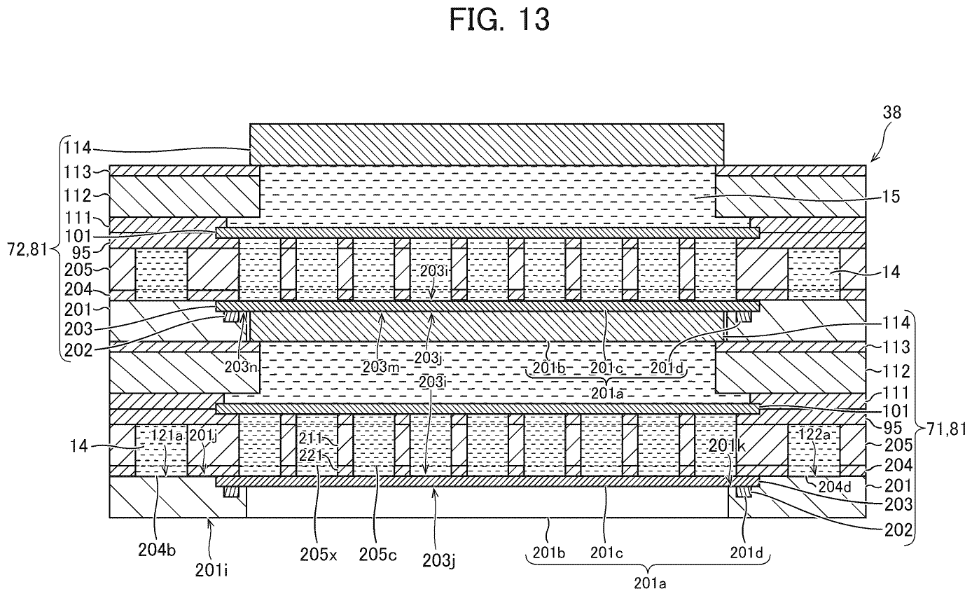

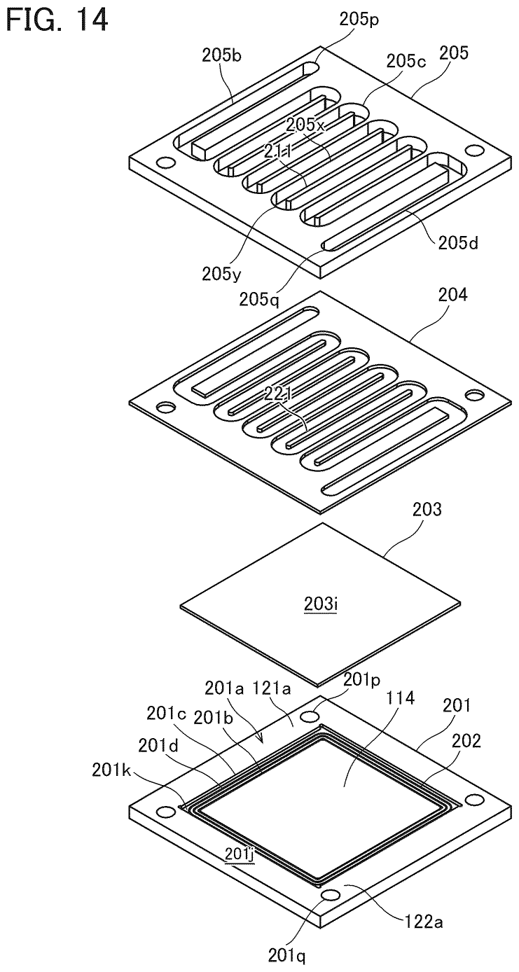

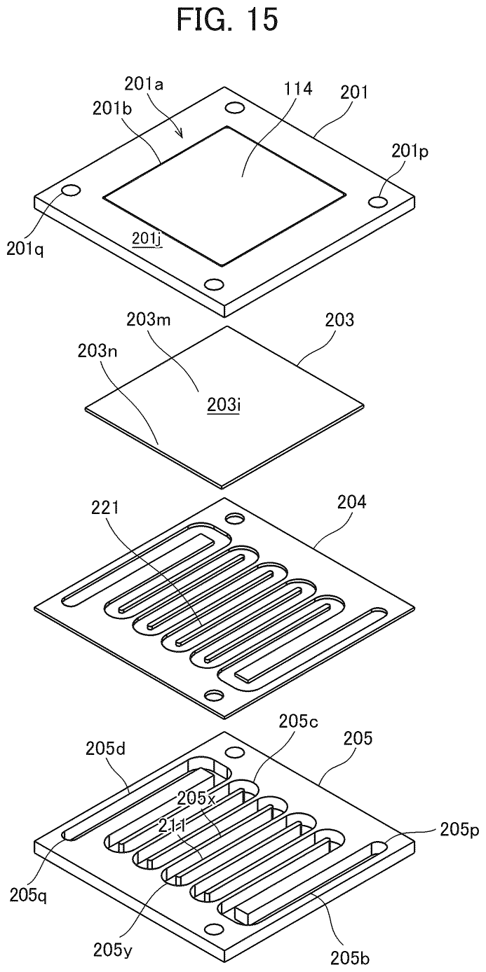

FIG. 13 is a schematic cross-sectional view of the charging stack, negative-electrode solution, and positive-electrode solution included in the metal-air flow battery according to the second embodiment. FIGS. 14 and 15 are schematic exploded perspective views of an insulating member, a seal portion, a negative electrode, a seal portion, and a negative-electrode flow-channel layer all included in the metal-air flow battery according to the second embodiment.

In the second embodiment, each charging cell 81 includes an insulating member 201, a seal portion 202, a negative electrode 203, a seal portion 204, and a negative-electrode flow-channel layer 205, as illustrated in FIGS. 13 to 15, instead of the frame 91, seal portion 92, negative electrode 93, and negative-electrode flow-channel layer 94 according to the first embodiment.

The insulating member 201 has a frame shape. The insulating member 201 thus includes an opening 201a. The opening 201a is formed in the middle of the insulating member 201. The opening 201a includes a first recess 201b, a second recess 201c, and a third recess 201d. The insulating member 201 includes a first main surface 201i and a second main surface 201j. The first main surface 201i and the second main surface 201j are opposite to each other. The first recess 201b is formed close to the first main surface 201i. The second recess 201c is formed close to the second main surface 201j. The first recess 201b and the second recess 201c are connected to each other between the first main surface 201i and the second main surface 201j. The first recess 201b has a planar shape smaller than the planar shape of the second recess 201c. The insulating member 201 includes a facing surface 201k at the outer edge of the first recess 201b. The facing surface 201k faces the edge of a back surface 203j of the negative electrode 203. The third recess 201d is formed on the facing surface 201k. The first recess 201b has a shape matching the shape of the positive electrode 114. The second recess 201c has a shape matching the shape of the negative electrode 203. The third recess 201d has a shape matching the shape of the seal portion 202. The third recess 201d is an annular groove. The negative-electrode flow-channel layer 205 includes a first flow channel 205b and a second flow channel 205d both penetrating the negative-electrode flow-channel layer 205 in the thickness direction of the negative-electrode flow-channel layer 205. The insulating member 201 includes the first lower surface 121a and the second lower surface 122a disposed perpendicularly below the first flow channel 205b and the second flow channel 205d, respectively.

The insulating member 201 includes holes 201p and 201q. The holes 201p and 201q penetrate the the insulating member 201 in the thickness direction of the insulating member 201.

The seal portion 202 has an annular shape. The seal portion 202 is fitted in the third recess 201d. The seal portion 202 is fitted in the third recess 201d, which is formed on the facing surface 201k of the insulating member 201 facing the edge of the back surface 203j of the negative electrode 203, and the seal portion 202 is thus disposed on and sandwiched by the back surface 203j and the facing surface 201k. The seal portion 202 may be an elastic body, such as rubber, or a portion formed by welding, fusing, or bonding the insulating member 201 and the negative electrode 203 to each other. In view of maintainability, it is desirable to use an elastic body, such as rubber, for the seal portion 202 because the seal portion 202 can be disintegrated even after assembly. The seal portion 202 seals the space between the negative electrode 203 and the insulating member 201. The seal portion 202 included in the charging cell 72 thus blocks a flow path of the negative-electrode solution 14 extending from the negative-electrode surface 203i of the negative electrode 203 included in the charging cell 72 to the positive electrode 114 included in the adjacent charging cell 71, which is adjacent to the charging cell 72. The seal portion 202 is disposed on the back surface 203j, so that a step difference can be prevented from being formed close to the negative-electrode surface 203i of the negative electrode 203 for sealing.

The negative electrode 203 is fitted in the second recess 201c of the insulating member 201. The negative electrode 203 is disposed in the opening 201a of the insulating member 201. The second main surface 201j of the insulating member 201 and the negative-electrode surface 203i of the negative electrode 203 are flush with each other.

The positive electrode 114 included in the charging cell 71 is disposed in the first recess 201b of the insulating member 201 included in the adjacent charging cell 72, which is adjacent to the charging cell 71. The positive electrode 114 included in the charging cell 71 is disposed in the opening 201a of the insulating member 201 included in the adjacent charging cell 72. The positive electrode 114 included in the charging cell 71 and the negative electrode 203 included in the adjacent charging cell 72 are respectively disposed in the first recess 201b and the second recess 201c connected to each other, so that the positive electrode 114 included in the charging cell 71 and the negative electrode 203 included in the adjacent charging cell 72 can be brought into contact with each other. This can electrically connect together the positive electrode 114 included in the charging cell 71 and the negative electrode 203 included in the adjacent charging cell 72.

The negative electrode 203 has a shape smaller than the planar shape of the positive electrode 114. The back surface 203j of the negative electrode 203 included in the charging cell 72 includes a first region 203m facing the positive electrode 114 included in the adjacent charging cell 71, and a second region 203n not facing the positive electrode 114 included in the adjacent charging cell 71. The seal portion 202 included in the charging cell 72 is disposed on the second region 203n. This can block the flow path of the negative-electrode solution 14, which extends from the negative-electrode surface 203i of the negative electrode 203 included in the charging cell 72 to the positive electrode 114 included in the adjacent charging cell 71, while electrically connecting together the negative electrode 203 included in the charging cell 72 and the positive electrode 114 included in the adjacent charging cell 71.

The seal portion 204 has a planar shape identical to the planar shape of the negative-electrode flow-channel layer 205.

The seal portion 204 is sandwiched by a composite of the insulating member 201, seal portion 202 and negative electrode 203, and by the negative-electrode flow-channel layer 205. The seal portion 204 has a sheet shape. The seal portion 204 is formed from an elastic body, such as rubber. The seal portion 204 seals the space between the composite of the insulating member 201, seal portion 202 and negative electrode 203 and the negative-electrode flow-channel layer 205.

The negative-electrode flow-channel layer 205 includes a negative-electrode chamber 205c that is a flow channel having a zigzag planar shape. The negative-electrode chamber 205c thus has a plurality of parallel sections 205x and a plurality of corner sections 205y. The negative-electrode flow-channel layer 205 also includes partitions 211 separating the plurality of parallel sections 205x from each other. The plurality of parallel sections 205x is parallel to each other. Each of the plurality of corner sections 205y connects one end of one of two adjacent parallel sections 205x included in the plurality of parallel sections 205x to one end of the other adjacent parallel section 205x. Accordingly, the negative-electrode flow-channel layer 205 guides the negative-electrode solution 14 from one of the parallel sections 205x through a corresponding one of the corner sections 205y to another one of the parallel sections 205x downstream of the parallel section 205x.

Between each partition 211 and the negative electrode 203 is a partition-to-negative-electrode seal portion 221 sealing the space between the partition 211 and the negative electrode 203. The partition-to-negative-electrode seal portion 221 is a part of the seal portion 204. Accordingly, a part of the negative-electrode solution 14 to be guided from the parallel section 205x through the corner section 205y to the downstream parallel section 205x can be prevented from flowing between the partition 211 and the negative electrode 203. This can prevent a part of the negative-electrode solution 14 from bypassing and flowing through a part of the negative-electrode chamber 205c. Accordingly, the flow rate of the negative-electrode solution 14 flowing through the negative-electrode chamber 205c can be prevented from decrease. This can thus prevent the negative-electrode active-material particles from accumulating in the negative-electrode chamber 205c.

The negative-electrode flow-channel layer 205 includes an inlet 205p and an outlet 205q. The inlet 205p and the outlet 205q penetrate the negative-electrode flow-channel layer 205 in the thickness direction of the negative-electrode flow-channel layer 205.

The hole 201p and the inlet 205p extend along the same straight line, have the same hole shape and constitute the first manifold through which the negative-electrode solution 14 flows.

The hole 201q and the outlet 205q extend along the same straight line, have the same hole shape and constitute the second manifold through which the negative-electrode solution 14 flows.

The charging stack 38 guides the negative-electrode solution 14 from the first manifold through the first flow channel 205b, through the negative-electrode chamber 205c, through the second flow channel 205d to the second manifold.

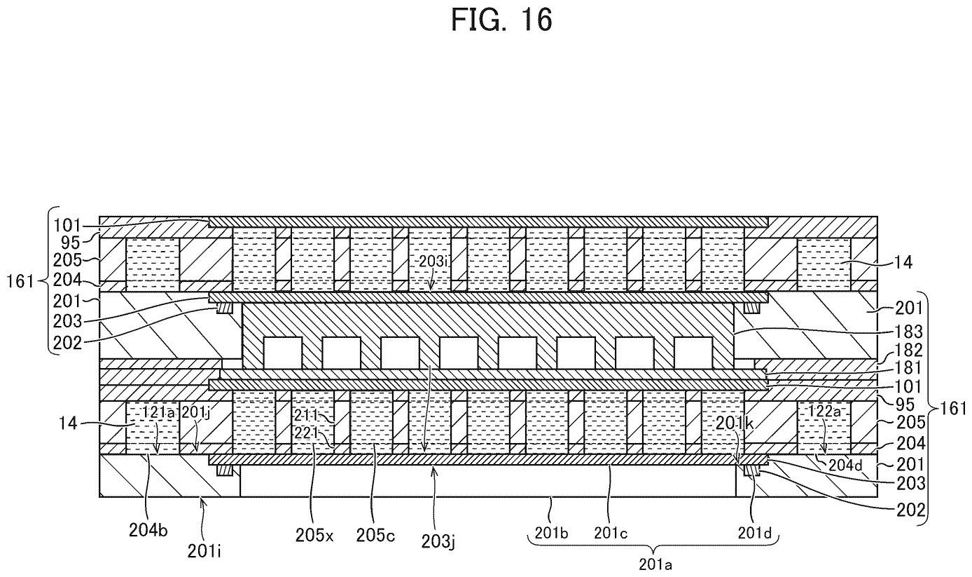

In the second embodiment, the discharging cell 161 includes a positive electrode 181, a seal portion 182, and a positive-electrode flow-channel layer 183 instead of the seal portion 111, positive-electrode flow-channel layer 112, seal portion 113, and positive electrode 114 included in each charging cell 81. FIG. 16 is a schematic cross-sectional view of another example discharging cell included in the metal-air flow battery according to the second embodiment. As illustrated in FIG. 16, the discharging cell 161 includes the positive electrode 181, the seal portion 182, and the positive-electrode flow-channel layer 183 instead of the seal portion 111, positive-electrode flow-channel layer 112, seal portion 113, and positive electrode 114 included in each charging cell 81. The charging cell 71 illustrated in FIG. 13 is structured such that the positive electrode 114 is disposed in the opening 201a of the insulating member 201, whereas the charging cell 71 illustrated in FIG. 16 is structured such that the positive-electrode flow-channel layer 183 is disposed in the opening 201a of the insulating member 201.

The present disclosure is not limited to the above-described embodiments. The present disclosure may be replaced with a configuration substantially identical to that described in the above-described embodiments, a configuration that provides the same action and effect, or a configuration that can achieve the same object.

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. A metal-air flow battery cell comprising:
a negative-electrode flow-channel layer including an inlet, a first flow channel, a negative-electrode chamber, a second flow channel, and an outlet, the negative-electrode flow-channel layer being configured to guide a slurry containing active-material particles and an electrolytic solution from the inlet sequentially through the first flow channel, through the negative-electrode chamber, through the second flow channel to the outlet, the negative-electrode chamber including an entrance and an exit, the entrance being connected to the first flow channel, the exit being connected to the second flow channel; and
a negative electrode including a negative-electrode surface disposed perpendicularly below the negative-electrode chamber,
wherein the negative-electrode surface and a first lower surface are arranged along a first coplanar plane at the entrance, the first lower surface being disposed perpendicularly below the first flow channel, and
the negative-electrode surface and a second lower surface are arranged along a second coplanar plane at the exit, the second lower surface being disposed perpendicularly below the second flow channel.

2. The metal-air flow battery cell according to claim 1, wherein
a difference between a perpendicular position of the negative-electrode surface and a perpendicular position of the first lower surface is equal to or less than an average particle diameter of the active-material particles at the entrance, and
a difference between the perpendicular position of the negative-electrode surface and a perpendicular position of the second lower surface is equal to or less than the average particle diameter at the exit.

3. The metal-air flow battery cell according to claim 1, wherein
a difference between a perpendicular position of the negative-electrode surface and a perpendicular position of the first lower surface is equal to or less than 100 μm at the entrance, and
a difference between the perpendicular position of the negative-electrode surface and a perpendicular position of the second lower surface is equal to or less than 100 μm at the exit.

4. The metal-air flow battery cell according to claim 1, wherein
a difference between a perpendicular position of the negative-electrode surface and a perpendicular position of the first lower surface is equal to or less than 50 μm at the entrance, and
a difference between the perpendicular position of the negative-electrode surface and a perpendicular position of the second lower surface is equal to or less than 50 μm at the exit.

5. The metal-air flow battery cell according to claim 1, wherein
a perpendicular position of the negative-electrode surface is lower than a perpendicular position of the first lower surface, and
a perpendicular position of the second lower surface is lower than the perpendicular position of the negative-electrode surface.

6. The metal-air flow battery cell according to claim 1, wherein the negative-electrode surface, the first lower surface, and the second lower surface are flush with one another.

7. The metal-air flow battery cell according to claim 1, comprising:
a first insulating portion formed from an insulator and including the first lower surface;
a second insulating portion formed from an insulator and including the second lower surface;
a first seal portion sealing a space between the negative electrode and the first insulating portion; and
a second seal portion sealing a space between the negative electrode and the second insulating portion,
wherein a perpendicular position of an upper end of the first insulating portion is equal to or lower than a perpendicular position of the negative-electrode surface, and equal to or lower than a perpendicular position of the first lower surface, and
a perpendicular position of an upper end of the second insulating portion is equal to or lower than the perpendicular position of the negative-electrode surface, and equal to or lower than a perpendicular position of the second lower surface.

8. The metal-air flow battery cell according to claim 7, wherein
the first seal portion is a portion formed by welding, fusing, or bonding the negative electrode and the first insulating portion to each other, and
the second seal portion is a portion formed by welding, fusing, or bonding the negative electrode and the second insulating portion to each other.

9. The metal-air flow battery cell according to claim 1, wherein
the negative electrode includes a back surface opposite to the negative-electrode surface, and
the metal-air flow battery cell comprises:
an insulating member including the first lower surface and the second lower surface; and
a seal portion disposed on the back surface and sealing a space between the negative electrode and the insulating member.

10. The metal-air flow battery cell according to claim 9, wherein
the insulating member includes a facing surface facing the back surface, and
the seal portion is disposed on the facing surface.

11. The metal-air flow battery cell according to claim 9, wherein the seal portion has an annular shape.

12. The metal-air flow battery cell according to claim 9, wherein the insulating member includes a recess in which the negative electrode is fitted.

13. The metal-air flow battery cell according to claim 1, wherein
the negative-electrode chamber includes a plurality of sections,
the negative-electrode flow-channel layer includes a partition separating the plurality of sections from each other, and
the metal-air flow battery cell comprises a partition-to-negative-electrode seal portion sealing a space between the partition and the negative electrode.

14. The metal-air flow battery cell according to claim 1, wherein
the negative-electrode flow-channel layer includes a recess in which the negative electrode is fitted, and
the negative-electrode flow-channel layer includes the first lower surface and the second lower surface.

15. The metal-air flow battery cell according to claim 14, comprising:
a frame including an opening having a planar shape smaller than a planar shape of the negative electrode; and
a seal portion having a planar shape identical to the planar shape of the frame, and sealing a space between the frame and a composite of the negative-electrode flow-channel layer and the negative electrode.

16. A metal-air flow battery stack comprising:
the metal-air flow battery cell according to claim 9; and
an adjacent metal-air flow battery cell adjacent to the metal-air flow battery cell,
wherein the adjacent metal-air flow battery cell includes a positive electrode adjacent to the negative electrode, and
the seal portion blocks a flow path of the slurry extending from the negative-electrode surface to the positive electrode.

17. The metal-air flow battery stack according to claim 16, wherein the insulating member includes an opening in which the negative electrode and the positive electrode are disposed.

18. The metal-air flow battery stack according to claim 16, wherein
the back surface includes
a first region facing the positive electrode, and
a second region not facing the positive electrode and surrounding the first region, and
the seal portion is disposed on the second region.
